(19) United States
(12) Patent Application Publication
(10) Pub. No.: US 2025/0315707 A1
(43) Pub. Date: Oct. 9, 2025

(54) CONTROLLER WITH CO-PROCESSOR, METHOD, MEDIUM, AND DEVICE FOR QUANTUM COMPUTER

(71) Applicant: ANYON TECHNOLOGIES PTE. LTD., Singapore (SG)

(72) Inventors: Lin MA, Singapore (SG); Cecil ACCETTI, Singapore (SG); Hengjiang REN, Singapore (SG); Jie LUO, Singapore (SG)

(73) Assignee: ANYON TECHNOLOGIES PTE. LTD., Singapore (SG)

(21) Appl. No.: 19/095,073

(22) Filed: Mar. 31, 2025

(30) Foreign Application Priority Data
Apr. 3, 2024 (CN) 2024103989940

(51) Int. Cl. G06N 10/20; G06N 10/80

(52) U.S. Cl. CPC G06N 10/20; G06N 10/80

(57) ABSTRACT

An electronic controller with a co-processor, a control method, a medium, and an electronic device are provided. The electronic controller is used for a quantum computer and comprises the first device and the second device. The first device comprises a compiler. The second device is communicatively connected to the first device and comprises a DSP and the co-processor. The compiler is configured to: obtain a quantum program written in the first programming language by a user; in response to the quantum program corresponding to the DSP, translate the quantum program into an API in the second programming language, and send an instruction contained in the API to the DSP; and in response to the quantum program corresponding to the co-processor, translate the quantum program into a program in the third programming language, generate an executable file, and send the executable file to the co-processor.

### FIELD OF THE INVENTION

The present disclosure relates to the technical field of quantum computing and in particular, to an electronic controller having a co-processor, a control method, a medium, and an electronic device for a quantum computer.

### BACKGROUND OF THE INVENTION

Quantum computers utilize quantum bits, or qubits, to store and process information. Unlike traditional bits, qubits can represent not only the states of 0 and 1 but also a superposition of multiple states simultaneously. A defining feature of quantum computers is quantum entanglement, which allows qubits to become interconnected. This entanglement property facilitates more efficient and secure methods for transmitting and processing information. Electronic controllers are critical components in quantum computing systems. By interfacing with quantum computers and other subsystems, the controllers ensure that the machines execute algorithms and instructions as intended. However, the electronic controllers currently used in quantum computers still have certain limitations.

### SUMMARY OF THE INVENTION

An electronic controller with a co-processor, a control method, a medium, and an electronic device for a quantum computer is provided.

A first embodiment of the present disclosure provides an electronic controller with a co-processor. The electronic controller is used for a quantum computer and comprises a first device and a second device. The first device comprises a compiler. The second device is communicatively connected to the first device and comprises a digital signal processor and the co-processor. The compiler is configured to: obtain a quantum program written in a first programming language by a user; in response to the quantum program corresponding to the digital signal processor, translate the quantum program into an application programming interface in a second programming language, and send an instruction contained in the application programming interface to the digital signal processor; and in response to the quantum program corresponding to the co-processor, translate the quantum program into a program in a third programming language, generate an executable file, and send the executable file to the co-processor.

In some examples of the present disclosure, the compiler is further configured to: when the quantum program comprises a capture instruction, determine whether the quantum program corresponds to the digital signal processor, and if not, determine whether the quantum program corresponds to the co-processor.

In some examples of the present disclosure, after a preset time interval, the capture instruction controls the digital signal processor to read pulses returned from the quantum computer by an analog-to-digital converter, and demodulate the pulses.

In some examples of the present disclosure, the co-processor supports a merging instruction, and the merging instruction combines commonly used basic instructions.

In some examples of the present disclosure, the co-processor comprises a system register, memories, a processor core, a debugging module, an interrupt controller, a core local controller, an arbiter, a scheduler, and a register mapping interface module.

In some examples of the present disclosure, the co-processor is further configured to: receive a trigger signal sent by the digital signal processor or the first device, read the executable file from memories of the co-processor, and execute the executable file.

In some examples of the present disclosure, the executable file comprises a function call, and each of the memories of the co-processor is pre-stored with a function body. When the executable file is executed, the co-processor invokes and executes a corresponding function body based on the function call.

A second embodiment of the present disclosure provides a method for controlling a quantum computer, comprising: receiving, by a first device, a quantum program written in a first programming language by a user; in response to the quantum program corresponding to a digital signal processor of a second device, translating, by a compiler of the first device, the quantum program into an application programming interface in a second programming language, and sending, by the first device, an instruction contained in the application programming interface to the digital signal processor; and in response to the quantum program corresponding to a co-processor of the second device, translating, by the compiler of the first device, the quantum program into a program in a third programming language, generating an executable file, and sending the executable file to the co-processor.

A third embodiment of the present disclosure provides a non-transitory computer-readable storage medium, which stores a computer program. The method as described in the examples provided in the second embodiment of the present disclosure is implemented when the computer program is executed by a processor.

A fourth embodiment of the present disclosure provides an electronic device, comprising a memory and a processor. A computer program is stored on the memory. The processor is communicatively connected to the memory and is configured to invoke the computer program to: receive a quantum program written in a first programming language by a user; in response to the quantum program corresponding to a digital signal processor of a second device, translate, by a compiler, the quantum program into an application programming interface in a second programming language, and send an instruction contained in the application programming interface to the digital signal processor; and in response to the quantum program corresponding to a co-processor of the second device, translate, by the compiler, the quantum program into a program in a third programming language, generate an executable file, and send the executable file to the co-processor.

The presently disclosed electronic controller configures a co-processor into the second device, which allows users to effortlessly upload algorithm programs developed on the first device onto the second device for execution. Furthermore, both the co-processor and the digital signal processor are integrated into the second device, enabling the precise execution of user-defined algorithms, such as Quantum Error Correction (QEC), with nanosecond-level accuracy.

In the present disclosure, the co-processor is implemented using the RISC-V architecture, which optimizes the Instruction Set Architecture (ISA), allowing commonly used basic instructions to be merged, thereby enhancing overall device performance.

Additionally, the compiler automatically converts user-written programs, making all the intricacies of the co-processor and digital signal processor completely transparent to the user, enabling users to focus solely on quantum experiments, algorithms, and applications, significantly improving efficiency.

Finally, since the executable file for new tasks sent from the first device to the co-processor only contains the function call, the storage overhead for this file is reduced, and the transmission time is minimized.

### BRIEF DESCRIPTION OF DRAWINGS

FIG. 1 is a schematic block diagram of a quantum computing system according to an embodiment of the present disclosure.

FIG. 2 is a working flowchart of a compiler according to an embodiment of the present disclosure.

FIG. 3 is a schematic structural diagram of a digital signal processor (DSP) system and a microcontroller unit (MCU) system according to an embodiment of the present disclosure.

FIG. 4A is a flowchart of the compiler translating a quantum program into a program in a third programming language according to an embodiment of the present disclosure.

FIGS. 4B to 4F are diagrams showing a translation process according to an embodiment of the present disclosure.

FIG. 5 is a flowchart of a method for controlling a quantum computer according to an embodiment of the present disclosure.

FIG. 6 is a schematic block diagram of an electronic device according to an embodiment of the present disclosure.

### REFERENCE NUMERALS

S21 to S23 Steps S21 to S23
S41 to S45 Steps S41 to S45
S51 to S55 Steps S51 to S55
600 Electronic device
610 Memory
620 Processor
630 Display

### DETAILED DESCRIPTION OF THE INVENTION

The embodiments of the present disclosure will be described below. Those skilled can easily understand other advantages and effects of the present disclosure according to contents disclosed by the specification. The present disclosure can also be implemented or applied through other different specific embodiments. Various details in this specification can also be modified or changed based on different viewpoints and disclosures without departing from the spirit of the present disclosure. It should be noted that the following embodiments and features of the following embodiments can be combined with each other if no conflict will result.

It should be noted that the drawings provided in this disclosure only illustrate the basic concept of the present disclosure in a schematic way, so the drawings only show the components closely related to the present disclosure. The drawings are not necessarily drawn according to the number, shape and size of the components in actual implementation; during the actual implementation, the type, quantity and proportion of each component can be changed as needed, and the layout of the components can also be more complicated.

In the following detailed description, the terms like “first” and “second” are used for indication purpose only and should not be construed as indicating or implying relative importance or implicitly specifying numbers of technical features indicated. Thus, features qualified with terms like “first” and “second” may explicitly or implicitly include at least one such feature. In the present disclosure, “a plurality of” means two or more, unless otherwise expressly specified.

In the present disclosure, unless otherwise expressly specified, terms such as “connection” and “coupling” should be broadly understood. For example, when one element is referred to as being “connected to” another element, one element may be mechanically connected to or electrically connected to another element, may be directly connected to another element, or may be indirectly connected to another element with another element interposed therebetween. These two elements may also communicate with each other internally or interact with each other. Those of ordinary skill in the art can understand the specific meanings of the above terms in the present disclosure according to specific situations.

Some existing technical solutions do not integrate a processor capable of running a real-time operating system (RTOS processor) that supports convenient programming languages (e.g., C language) with a DSP capable of completing front- end digital signal processing within a 100-nanosecond latency, all on a single chip. Additionally, in these solutions, the processor and the DSP are entirely separated in terms of logic and control, resulting in limited performance and ease of use.

To address these issues, the present disclosure provides an electronic controller with a co-processor. The following sections detail the electronic controller using specific embodiments and accompanying diagrams.

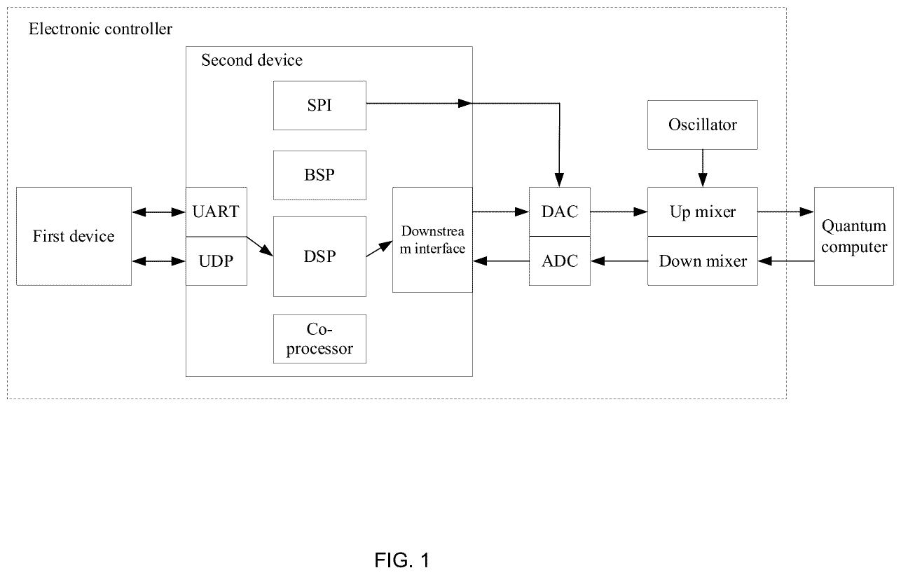

FIG. 1 is a schematic block diagram of a quantum computing system. As shown in FIG. 1, the quantum computing system comprises an electronic controller and a quantum computer. The electronic controller comprises a first device and a second device, and the second device is communicatively connected to the first device. For example, the second device may be connected to the first device by Ethernet. The first device can be a Personal Computer (PC), and the second device can be a Field-Programmable Gate Array (FPGA). Additionally, the electronic controller may further comprise a Digital-to-Analog Converter (DAC), an Analog-to-Digital Converter (ADC), an up mixer, a down mixer, and an oscillator.

The first device offers a Graphical User Interface (GUI) for users, allowing them to input instructions for configuring signal parameters during communication. The first device also provides a programming interface for users to develop custom quantum programs using tools such as the Open Quantum Assembly Language (openQASM), which is a programming language designed for describing quantum circuits and algorithms for execution on quantum computers, or Qiskit-software stack for quantum computing.

The second device acts as an intermediary between the first device and the quantum computer, facilitating the transmission of control commands, data, and results. The second device is also equipped with parallel computing capabilities and programmability, enabling it to perform tasks like data preprocessing, format conversion, data processing, and modulation/demodulation to meet specific application needs.

In certain implementations, the second device can communicate with the first device using a User Datagram Protocol (UDP) interface and a Universal Asynchronous Receiver-Transmitter (UART) interface. UDP is a connectionless protocol that enables high-speed, high-throughput, and low-latency data transmission between the first device and the second device, while UART is a serial communication protocol designed to offer reliable serial communication between the two devices. For example, the UART interface can be used for device maintenance and debugging. Users can send instructions from the first device through the UART interface, which are then transmitted to the second device and further passed via the Serial Peripheral Interface (SPI) protocol to configure the ADC and/or DAC.

In some implementations, the second device communicates with data converters (e.g., ADC and DAC) through a downstream interface. The downstream interface enables high-speed serial communication with deterministic latency between the second device and the converters under varying environmental and power cycling conditions.

In some implementations, the second device may also comprise a DSP system and a Board Support Package (BSP). The DSP system comprises a DSP. The DSP handles digital signal processing tasks, while the BSP is a software package designed to support specific hardware at the board level, providing essential software components and drivers.

The DAC converts digital signals from the second device into analog signals and then sends the analog signals to the up mixer. The ADC receives downstream analog signals from the down mixers, and converts the downstream analog signals into digital signals for the second device.

The up mixer mixes upstream signals (i.e., the analog signals converted by DAC) with oscillator-provided signals to raise signal frequency for channel transmission. The down mixer mixes the downstream analog signals with the oscillator-provided signals to lower signal frequency, allowing the ADC and the second device to process the signals.

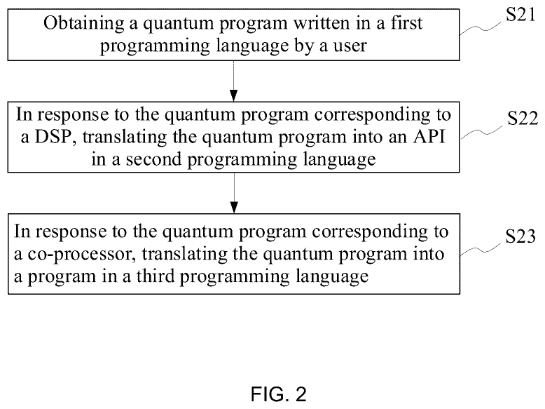

In the present disclosure, the compiler of the first device performs a translation method shown in FIG. 2. As shown in FIG. 2, the translation method comprises the following steps S21-S23.

Step S21 comprises: obtaining a quantum program written in a first programming language by a user. Exemplarily, the user may write the quantum program on the first device by using the first programming language, such as OpenQASM, Qlsklit.

Step S22 comprises: in response to the quantum program corresponding to the DSP, translating the quantum program into an application programming interface (API) in a second programming language, and sending an instruction contained in the API to the DSP. The instruction contained in the API can be stored in a memory of the DSP system. The second programming language is, for example, Python or C language.

Step S23 comprises: in response to the quantum program corresponding to the co-processor, translating the quantum program into a program in a third programming language, generating an executable file, and sending the executable file to the co-processor. The executable file can be stored in memories of the co-processor. The third programming language is, for example, a C language, and the program of the C language may be processed by using the GNU Compiler Collection (GCC) to generate the executable file.

In some implementations, the co-processor is implemented using a RISC-V architecture. The co-processor may employ a three-stage pipeline and support custom instructions for generating fixed-point arithmetic of any pulse envelope.

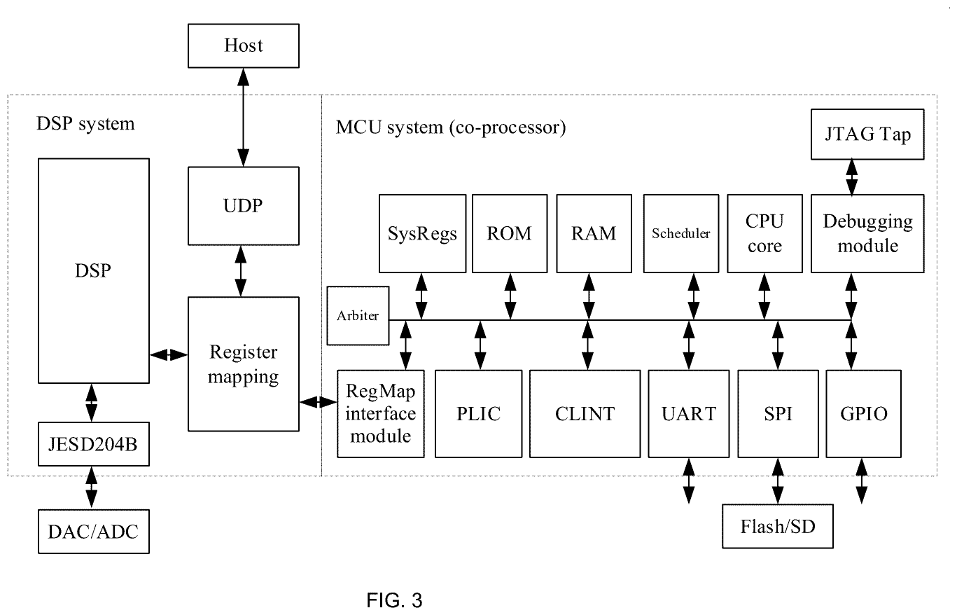

FIG. 3 is a schematic structural diagram of an MCU system (e.g., co-processor) and the DSP system according to an embodiment of the present disclosure. As shown in FIG. 3, the co-processor comprises a system register (SysRegs), a central processor unit (CPU) core, a debugging module, an interrupt controller (such as Platform-Level Interrupt Controller, PLIC), a core local controller (such as Core Local Interruptor, CLINT), an arbiter (Arb), a scheduler, and a register mapping (RegMap) interface module. The system register is configured to store and manage configuration information, state information, control information, and the like. The interrupt controller is configured to monitor and process interrupt requests from various components, ensuring that the co-processor responds promptly to external events and performs the necessary operations. The core local controller is configured to coordinate and manage various tasks within the quantum computing system, comprising initialization, operation and measurement of qubits, scheduling and execution of quantum gate operations, as well as error correction and entanglement maintenance. The arbiter is configured to process concurrent interrupt requests from multiple sources, such as those from the DSP and a register mapping, and determine which interrupt request should be preferentially processed. The scheduler is configured to run multiple user-uploaded tasks on CPU, following user-defined intervals and sequences. The scheduler supports real-time addition and deletion of tasks, along with real-time monitoring of task registers. The register mapping interface module is configured to connect the co-processor with the register mapping in the DSP system. Exemplarily, the register mapping interface module can access Ethernet register mapping (Ethernet Regmap) using a Wishbone protocol.

The co-processor may further comprise Read-Only Memory (ROM), Random Access Memory (RAM), and serial bus interfaces. The serial bus interfaces comprise UART interfaces, SPIs, and General-Purpose Input/Output (GPIO) interfaces. The co-processor can access SD/Flash memory using the serial bus interfaces, enabling stable firmware uploads and booting.

Exemplarily, the co-processor can access the GPIO interfaces through a Wishbone bus and utilize the Wishbone bus to access both dedicated and shared UARTs.

In some implementations, the co-processor may further comprise a Joint Test Action Group Test Access Port (JTAG TAP) to support debugging and testing of the quantum program by the debugging module. The debugging module uses the JTAG TAP for tasks such as firmware uploads and runtime debugging, ensuring compatibility with Open On-Chip Debugger (OpenOCD).

In some implementations, high-speed interaction between the co-processor and the DSP system is achieved through Direct Memory Access (DMA).

The DSP system comprises not only the DSP but also the UDP interface, the register mapping, and a JESD204B interface. The DSP communicates with a host (i.e., the first device) by the UDP interface and communicates with the ADC and DAC by the JESD204B interface.

In some implementations, the compiler is further configured to: when the quantum program comprises a capture instruction, determine whether the quantum program corresponds to the DSP, and if not, determine the quantum program corresponds to the co-processor.

Specifically, the presently disclosed electronic controller supports an OpenQASM-based quantum computer control flow (OpenQASM flow). Only the capture instruction is executed directly by the first device through the API to control the DSP. All other syntax-related operations involve interaction between the first device and the co-processor. The co-processor either relays these operations to the DSP for execution or executes these operations independently. Based on this, the compiler can determine whether the quantum program corresponds to the DSP or the co-processor by analyzing the types of instructions.

In some implementations, the capture instruction is used to control the DSP to read, after a preset time interval, pulses returned from the quantum computer by the ADC, demodulate the pulses, and obtain demodulated results. The demodulated results are subsequently sent to the host.

For instance, the compiler parses and maps the capture instruction to a corresponding API based on predefined files containing the quantum computer's physical information. The capture instruction is converted into commands to read specific registers at a designated internet protocol (IP) address at a certain moment. For example, an instruction of capture (q2) corresponds to an API call batch_register_read (“IP”, “starting register address”, “number of registers to read”). Here, capture is standard QASM syntax, batch_register_read is a name of the API call, and the parameters represent the IP address, the starting register address, and the number of registers to read, respectively. The API call communicates with the second device over the Ethernet to retrieve and return the relevant data.

In some implementations, the co-processor supports a merging instruction, and the merging instruction is obtained by combining commonly used basic instructions into one.

Exemplarily, in a quantum error-correction algorithm involving multiple qubits (e.g., if A && B && C && D && E==true, then next_pulse_en=true, else next_pulse_en=false), control waveform parameters for the next qubit can be adjusted in real time based on the states of the previous qubits (A, B, C, D, and E). The next pulse is sent only if next_pulse_en is true. General ISAs involve multiple memory fetches to retrieve input data (i.e., the recently measured states of qubits), numerous computations, and frequent interactions between Arithmetic Logic Units (ALUs) and memories. In the present disclosure, the states of the qubits are combined into a single 32-bit data word, and multiple logic operation instructions are merged into a single instruction, which reduces the frequency of interactions between the ALUs and the memories, significantly decreasing the time required to complete the quantum error-correction algorithm.

In some implementations, the co-processor is further configured to: receive a trigger signal sent by the DSP or the first device, read the executable file from the memories of the co-processor, and execute the executable file.

In some implementations, the executable file comprises a function call. Each of the memories of the co-processor is pre-stored with a function body. When the executable file is executed, the co-processor invokes and executes a corresponding function body based on the function call.

Exemplarily, the co-processor comprises three memories, referred to as a first memory, a second memory, and a third memory, respectively. The first memory is connected to the Ethernet and is used to store the received executable file. A developer may compile the frequently used function bodies and then upload them to the second memory. The third memory is used to store data generated during the function execution.

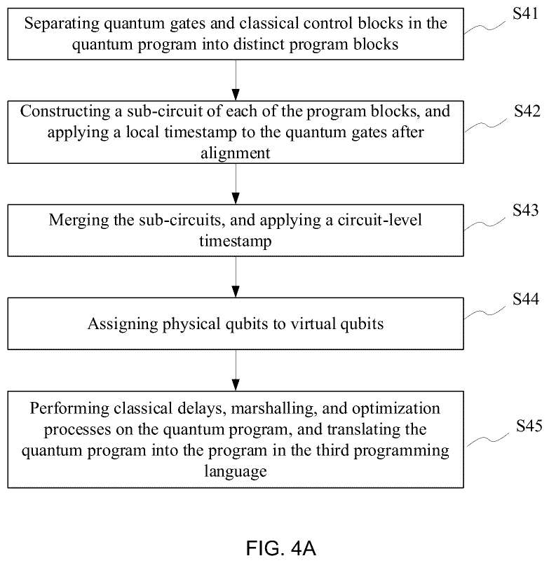

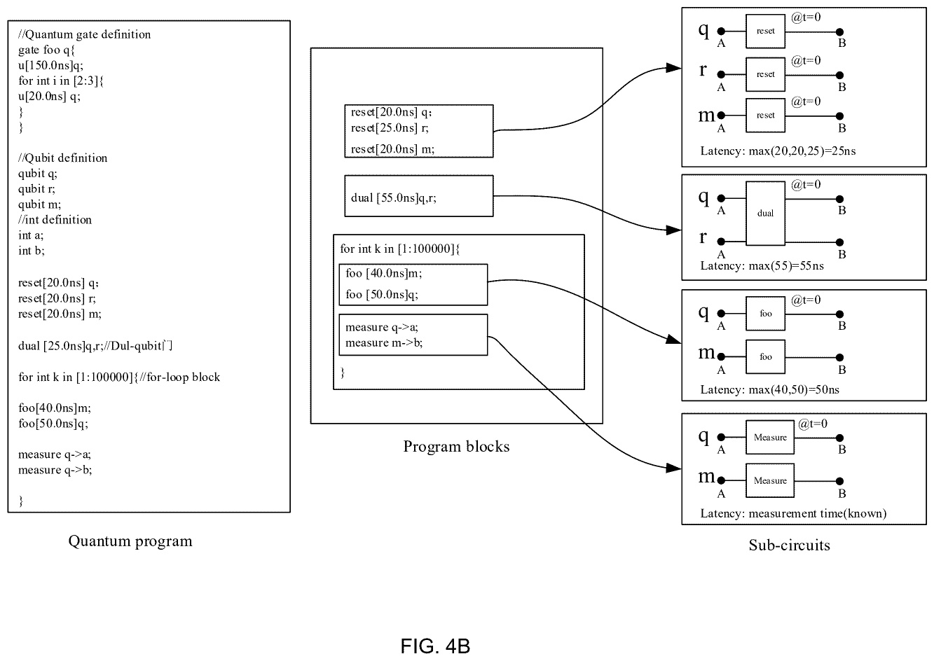

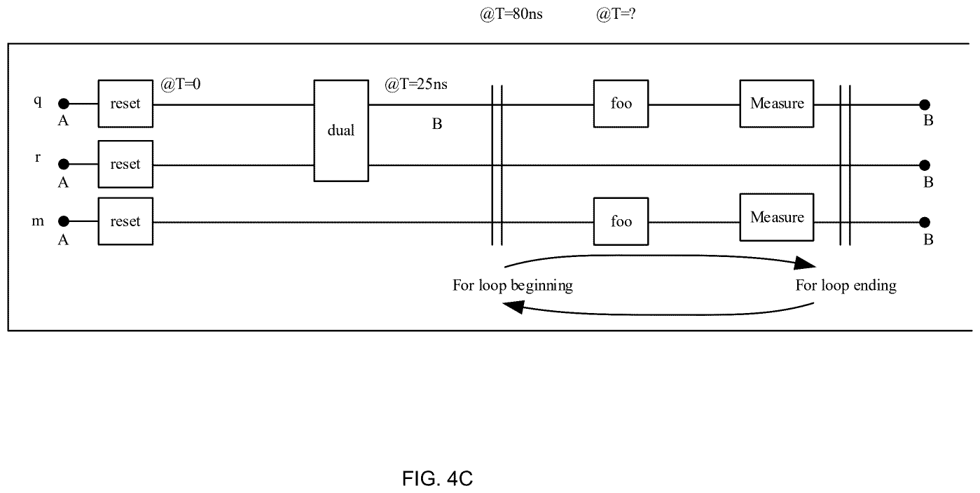

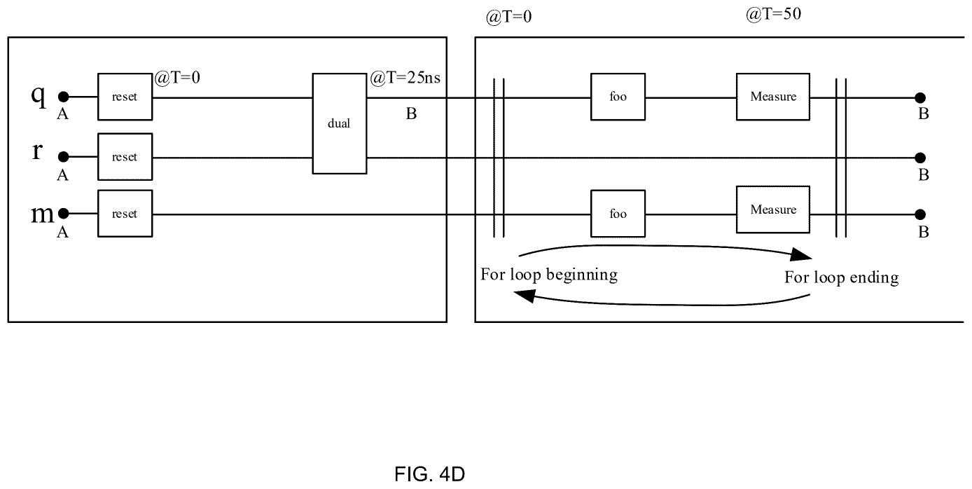

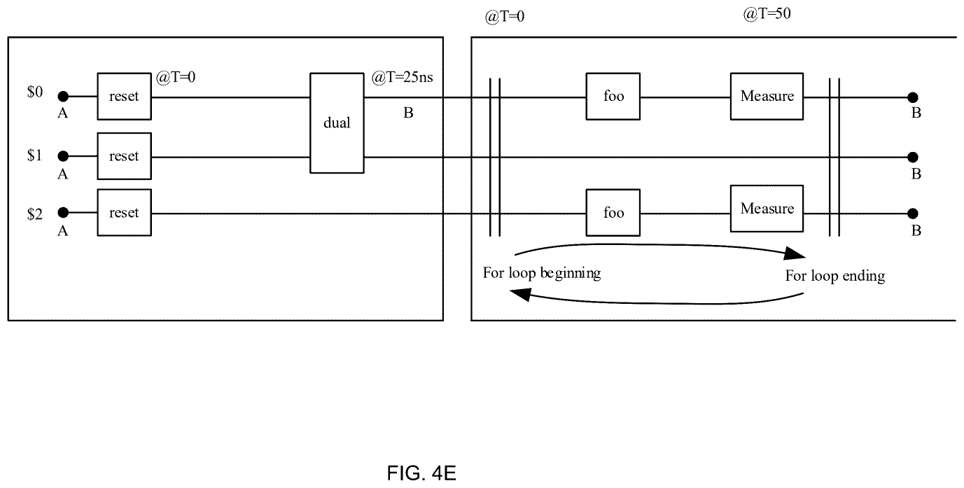

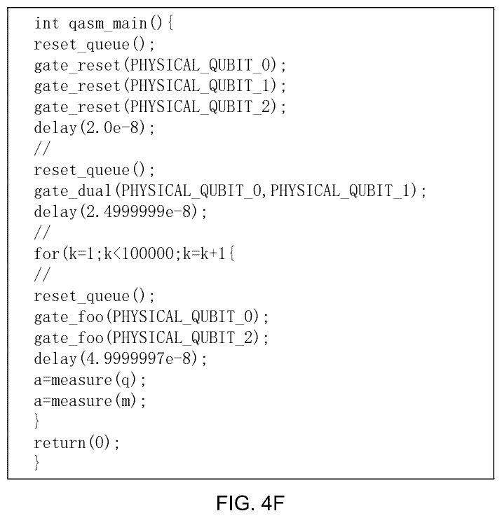

In some implementations, referring to FIG. 4A, the compiler translates the quantum program into the program in the third programming language by executing steps S41-S45.

Step S41 comprises: separating quantum gates and classical control blocks in the quantum program into distinct program blocks.

Step S42 comprises: constructing a sub-circuit of each of the program blocks, and applying a local timestamp to the quantum gates after alignment. The first programming language is QASAM. Examples for steps S41 and S42 are shown in FIG. 4B.

Step S43 comprises: merging the sub-circuits, and applying a circuit-level timestamp, as shown in FIG. 4C.

In step S43, managing the circuit-level timestamp within the loops can be challenging due to variable loop lengths and the influence of classical-domain processing. For the above problem, in the present disclosure, timing may be reset at the beginning of each cycle, as shown in FIG. 4D.

Step S44 comprises: assigning physical qubits to virtual qubits, as shown in FIG. 4E. Specifically, all qubit physical information is stored in a file, such as a JSON file. The compiler reads this file and incorporates the real machine physical information into the program, enabling the program to run on the quantum computer.

Step S45 comprises: performing classical delays, marshalling, and optimization processes on the quantum program, and translating the quantum program into the program in the third programming language. FIG. 4F is an example diagram showing a translation result when the third programming language is the C language. Classical delays account for potential processing delays during translation, such as those caused by data transmission or computation. Marshalling, or serialization, converts data structures or objects into a serialized byte stream. Optimization processes enhance the translated code's performance by reducing computational complexity, minimizing storage requirements, and improving execution efficiency.

Exemplarily, when the third programming language is the C language, GCC can compile the translated program of step S45 into the executable file. The executable file can be packaged in an API call and integrated with the API call for the DSP based on the compiler's specified generation order, to obtain a complete C or Python code, ready for execution.

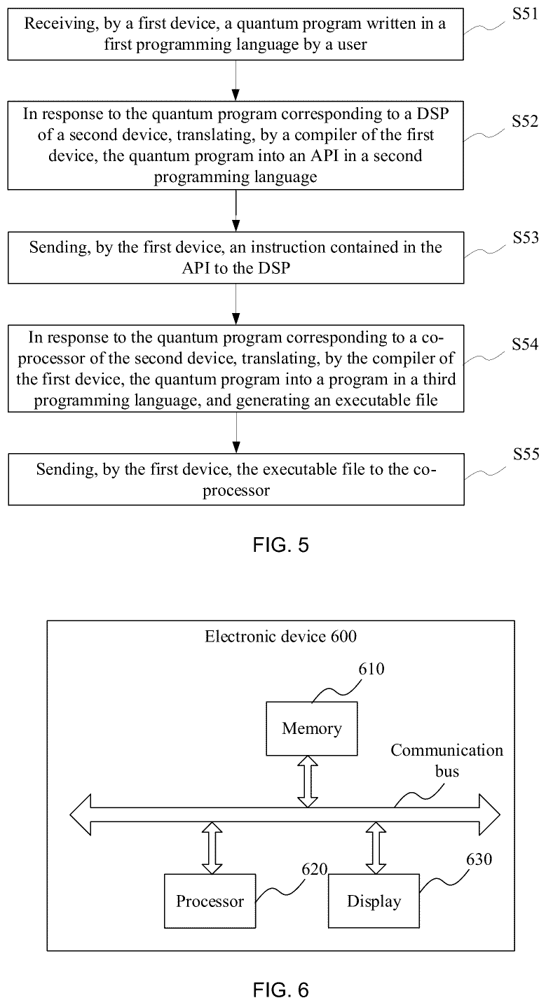

The present disclosure further provides a method for controlling a quantum computer, and FIG. 5 is a flowchart of the method. As shown in FIG. 5, the method comprises steps S51-S55.

Step S51 comprises: receiving, by a first device, a quantum program written in a first programming language by a user.

Step S52 comprises: in response to the quantum program corresponding to a DSP of the second device, translating, by a compiler of the first device, the quantum program into an API in a second programming language.

Step S53 comprises: sending, by the first device, an instruction contained in the API to the DSP.

Step S54 comprises: in response to the quantum program corresponding to a co-processor of the second device, translating, by the compiler of the first device, the quantum program into a program in a third programming language, and generating an executable file.

Step S55 comprises: sending the executable file to the co-processor.

The scope of the control method described in the present disclosure is not limited to the sequence of operations listed herein. Any scheme realized by adding or subtracting operations or replacing operations of the traditional techniques according to the principle of the present disclosure is included in the scope of the present disclosure.

In the several embodiments proposed in the present disclosure, the disclosed systems, devices, or methods can be implemented in other ways. For example, the embodiments of devices described above are only illustrative, and the division of modules or units is only a logical functional division. In actual implementation, there may be other division methods, such as multiple modules or units can be combined or integrated into another system, or some features can be ignored or not executed. Here, the coupling or direct coupling or communication connection between each other can be indirect coupling or communication connection through some interfaces, devices, modules, or units, and can be electrical connection, mechanical connection, or other connections.

The modules or units shown as separate components can be physically separated or not. The components shown as modules or units can be physical modules or not. That is, they can be located in one place, or they can also be distributed to multiple network units. Some or all of the modules or units can be selected as needed to achieve the purpose of the embodiment. For example, in one embodiment of the present disclosure, each functional module or unit can be integrated into one processing module. Each functional module or unit can exist physically separately, or two or more modules or units can be integrated into one module or unit.

The ordinary technical personnel in this field should further realize that the units and algorithm steps of each example described in combination with the embodiments disclosed here can be implemented by electronic hardware, computer software, or a combination of both. In the above description, each example's composition and steps have been described generally based on functions, so as to clearly illustrate the interchangeability of hardware and software. Whether these functions are executed by hardware or software depends on the specific application and design constraints of the technical solution. Professional technicians can use different methods to implement the functions described for each specific situation, but such implementation should not be considered beyond the scope of the present disclosure.

The present disclosure further provides a non-transitory computer-readable storage medium, which stores a computer program, and the control method as described in the present disclosure is implemented when the computer program is executed by a processor. Those skilled in the art can understand that, all or part of the steps in the method for implementing the above embodiments can be implemented when the computer program is executed by a processor. The non-transitory computer-readable storage medium may be, for example, random access memory, read-only memory, flash memory, hard disk, solid-state disk, magnetic tape, floppy disk, optical disc and any combination thereof. The above storage medium can be any available medium that can be accessed by a computer, or a data storage device that integrates one or more available media, such as a server, a data center, etc. The available medium can be a magnetic medium (such as a floppy disk, a hard disk, or a magnetic tape), an optical medium (such as a digital video disc (DVD)), or a semiconductor medium (such as a solid state disk (SSD)), etc.

The present disclosure further provides an electronic device 600. FIG. 6 shows a schematic block diagram of the electronic device 600. As shown in FIG. 6, the electronic device 600 comprises a memory 610 and a processor 620.

The memory 610 is configured to store a computer program. In some implementations, the memory 610 may comprise a volatile computer-readable storage medium, such as RAM and/or cache memory. The electronic device 600 may further comprise other removable/non-removable, volatile/nonvolatile computer system storage media. The memory 610 may comprise at least one program product, and the program product has a group of (for example, at least one) program modules, and these program modules are configured to implement the functions of the embodiments of the present disclosure.

The processor 620 is connected to the memory 610 for executing the computer program stored in the memory 610, to cause the electronic device 600 to perform the control method described above. The presently disclosed method for controlling the quantum computer comprises: receiving a quantum program written in a first programming language by a user; in response to the quantum program corresponding to a DSP of the second device, translating, by a compiler, the quantum program into an API in a second programming language, and sending an instruction contained in the API to the DSP; and in response to the quantum program corresponding to a co-processor of the second device, translating, by the compiler, the quantum program into a program in a third programming language, generating an executable file, and sending the executable file to the co-processor.

In some implementations, the processor 620 may be a general processor, including a CPU, a network processor (NP), and the like. In some other implementations, the processor 620 may also be a DSP, an application specific integrated circuit (ASIC), an FPGA, or other programmable logic devices, discrete gate or transistor logic devices, or discrete hardware components.

In some implementations, the electronic device 600 of the present disclosure may further comprise a display 630. The display 630 is communicatively connected to the memory 610 and the processor 620 for displaying a GUI related to the control method.

In the present disclosure, the display 630 may be a display screen (or, a display panel). In some embodiments, the display panel can be configured using technologies such as liquid crystal display (LCD), organic light-emitting diode (OLED), or the like. Additionally, the display 630 may be a touch panel (or, touch screen), which includes both a visual screen and a touch-sensitive surface. When the touch-sensitive surface detects touch interactions on or near it, the information will be transmitted to the processor 620 to determine the type of touch event, and then the processor 620 provides corresponding visual output on the display 630, based on the type of touch event.

The descriptions of the steps or structures corresponding to the drawings are respectively emphasized, and some steps or structures that are not detailed can be referred to the relevant descriptions of other steps or structures.

The presently disclosed electronic controller configures a co-processor into the second device, which allows users to effortlessly upload algorithm programs developed on the first device to the second device for execution. Furthermore, both the co-processor and the DSP are integrated into the second device, enabling the precise execution of user-defined algorithms, such as QEC, with nanosecond-level accuracy.

In the present disclosure, the co-processor is implemented using the RISC-V architecture, which optimizes ISA, allowing commonly used basic instructions to be merged, thereby enhancing overall device performance.

Additionally, the compiler automatically converts user-written programs, making all the intricacies of the co-processor and digital signal processor completely transparent to the user, enabling users to focus solely on quantum experiments, algorithms, and applications, significantly improving efficiency.

Finally, since the executable file for new tasks sent from the first device to the co-processor only contain the function call, the storage overhead for this file is reduced, and the transmission time are minimized.

Therefore, the present disclosure overcomes various shortcomings of the prior art and has a high industrial value.

The above-mentioned embodiments are merely illustrative of the principle and effects of the present disclosure instead of limiting the present disclosure. Those skilled in the art can make modifications or changes to the above-mentioned embodiments without going against the spirit and the range of the present disclosure. Therefore, all equivalent modifications or changes made by those who have common knowledge in the art without departing from the spirit and technical concept disclosed by the present disclosure shall be still covered by the claims of the present disclosure.

1. An electronic controller of a quantum computer, comprising:
a first device, comprising a compiler; and
a second device, comprising a digital signal processor and a co-processor,
wherein the second device is communicatively connected to the first device;
wherein the compiler is configured to:
obtain a quantum program written in a first programming language by a user;
in response to the quantum program corresponding to the digital signal processor, translate the quantum program into an application programming interface in a second programming language, and send an instruction contained in the application programming interface to the digital signal processor; and
in response to the quantum program corresponding to the co-processor, translate the quantum program into a program in a third programming language, and generate an executable file, and send the executable file to the co-processor.

2. The electronic controller according to claim 1, wherein the compiler is further configured to:
when the quantum program comprises a capture instruction, determine whether the quantum program corresponds to the digital signal processor, and if not, determine whether the quantum program corresponds to the co-processor.

3. The electronic controller according to claim 2, wherein, after a preset time interval, the capture instruction controls the digital signal processor to read pulses returned from the quantum computer by an analog-to-digital converter, and demodulate the pulses.

4. The electronic controller according to claim 1, wherein the co-processor supports a merging instruction, wherein the merging instruction combines commonly used basic instructions.

5. The electronic controller according to claim 1, wherein the co-processor comprises a system register, memories, a processor core, a debugging module, an interrupt controller, a core local controller, an arbiter, a scheduler, and a register mapping interface module.

6. The electronic controller according to claim 1, wherein the co-processor is further configured to:
receive a trigger signal sent by the digital signal processor or the first device, read the executable file from memories of the co-processor, and execute the executable file.

7. The electronic controller according to claim 5, wherein the executable file comprises a function call, wherein each of the memories of the co-processor is pre-stored with a function body; and
wherein when the executable file is executed, the co-processor invokes and executes a corresponding function body based on the function call.

8. A method for controlling a quantum computer, comprising:
receiving, by a first device, a quantum program written in a first programming language by a user;
in response to the quantum program corresponding to a digital signal processor of a second device, translating the quantum program into an application programming interface in a second programming language by a compiler of the first device;
sending, by the first device, an instruction contained in the application programming interface to the digital signal processor; and
in response to the quantum program corresponding to a co-processor of the second device, translating the quantum program into a program in a third programming language by the compiler of the first device;
generating an executable file, and sending the executable file to the co-processor.

9. The method for controlling the quantum computer according to claim 8, wherein the quantum program is stored in a non-transitory computer-readable storage medium, and wherein the quantum program is executed by the co-processor.

10. An electronic device, comprising:
a memory, on which a computer program is stored; and
a processor, communicatively connected to the memory and configured to invoke the computer program to:
receive a quantum program written in a first programming language by a user;
in response to the quantum program corresponding to a digital signal processor of a second device, translate the quantum program into an application programming interface in a second programming language by a compiler;
send an instruction contained in the application programming interface to the digital signal processor;
in response to the quantum program corresponding to a co-processor of the second device, translate the quantum program into a program in a third programming language by the compiler;
generate an executable file; and
send the executable file to the co-processor.
